(19) United States
(12) Patent Application Publication
(10) Pub. No.: US 2025/0370822 A1
(43) Pub. Date: Dec. 4, 2025

(54) FUNCTIONS TO IMPLEMENT TARGET MAPPINGS ON COMPUTING DEVICES

(71) Applicant: UNTETHER AI CORPORATION, Toronto (CA)

(72) Inventor: Andrew Vincent Rock, Toronto (CA)

(21) Appl. No.: 18/936,419

(22) Filed: Nov. 4, 2024

Related U.S. Application Data
(60) Provisional application No. 63/652,834, filed on May 29, 2024.

(51) Int. Cl. G06F 9/50; G06F 15/80

(52) U.S. Cl. CPC G06F 9/5066; G06F 15/8007

(57) ABSTRACT

A processor is configured to partition a target mapping of a target function into ranges. Candidate functions are fit to the ranges, such that a candidate function is fit to each range. The candidate functions and the ranges are adjusted based on a cost function. The cost function computes a processing load to execute the candidate functions with the ranges using an array of single instruction, multiple data (SIMD) processing elements. The processor selects the candidate functions and the ranges that minimize the cost function as operational functions and operational ranges that implement the target mapping.

### BACKGROUND

Computing devices often implement mathematical functions as part of their operations. Mathematical functions are often continuous in the sense that a real number input provides a real number output. A compromise typically needs to be made when implementing such functions due to the fact that computing devices operate on binary representations of numbers rather than real numbers. The compromise typically trades accuracy for reduced modeling complexity and speed. For example, a simplistic digitization of a function may have reduced complexity and may provide a result in few operational cycles, but it may have poor accuracy. A more complex digitization may have greater accuracy but may be slower to execute.

### BRIEF DESCRIPTION OF THE DRAWINGS

FIG. 1 is a diagram of a system that includes an example computing device and an example configuring computing device.

FIG. 2 is a diagram showing an example target function.

FIG. 3 is a diagram showing an example of operational functions over ranges implementing the target function of FIG. 2.

FIG. 4 is a flowchart of an example method for determining operational functions for a target function.

FIG. 5 is a diagram of an example system to determine operational functions for a target function.

### DETAILED DESCRIPTION

Disclosed herein are techniques to implement functions on computing devices with greater accuracy and performance characteristics, particularly for massively parallel computing devices, such single instruction, multiple data (SIMD) computing devices. Such functions, which may be activation functions, may include Gaussian Error Linear Unit (GELU), Rectified Linear Unit (ReLU), Exponential Linear Unit (ELU), swish, tanh, sigmoid, square root or sqrt(x), sine or sin(x), and e^{x}.

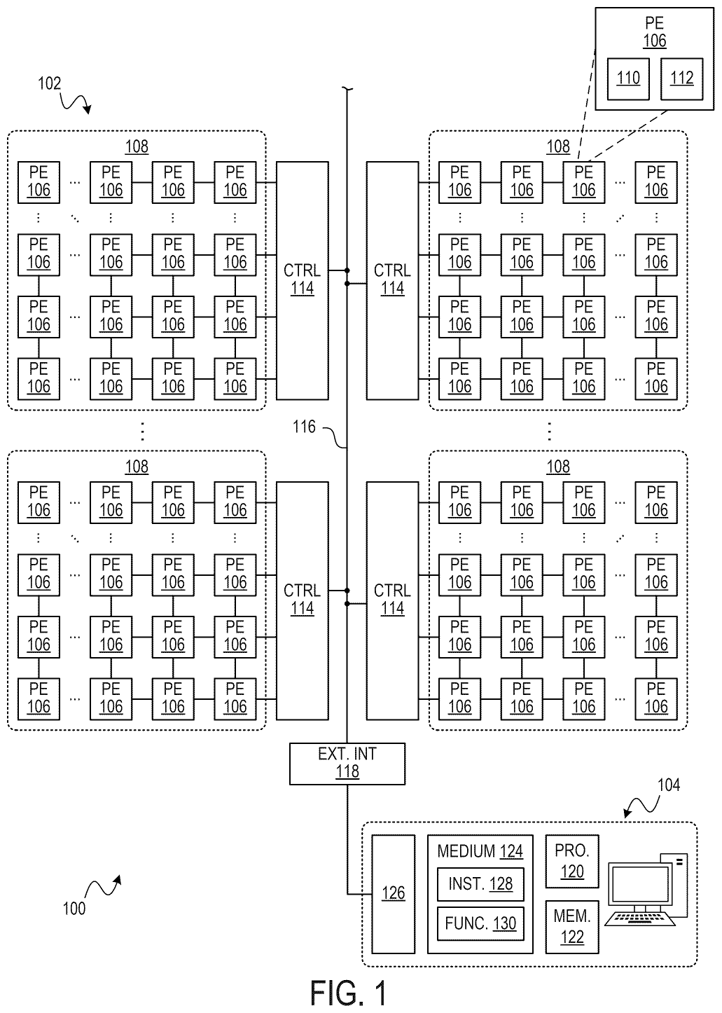

FIG. 1 shows an example system 100 that includes a SIMD computing device 102 and a configuring computing device 104. The SIMD computing device 102 is capable of executing programs to provide desired functionality, such as neural networks, artificial intelligence (AI) programs, machine vision programs, large-language models (LLM), and similar. The configuring computing device 104 configures the SIMD computing device 102 by, for example, providing an integrated development environment (IDE) and compiler for development and deployment of programs to the SIMD computing device 102.

The SIMD computing device 102 includes an array of processing elements 106 configured to operate in SIMD fashion. The device 102 may include hundreds, thousands, or hundreds of thousands of processing elements 106. A subset of the processing elements 106, such as a bank, row, column, etc., may be commanded to perform the same operation at the same time. Different subsets of processing elements may perform their respective operations at different times or at the same time. Various subsets of processing elements 106 may be configured prior to execution of a program. Additionally or alternatively, subsets of processing elements 106 may be configured at runtime.

The SIMD computing device 102 includes multiple banks 108 of processing elements 106. The bank 108 is a computing device, which may be termed a SIMD or at-memory computing device. U.S. Pat. No. 11,881,872, which is incorporated herein by reference, may be referenced for additional details concerning processing elements 106 and banks 108 thereof.

A bank 108 includes an array of processing elements or PEs 106. Processing elements 106 may be logically and, optionally, physically arranged in a two-dimensional array. Such an array may be considered to have rows and columns.

Each processing element 106 includes operational circuitry 110 to perform operations, such as multiplying accumulations. For example, each processing element 106 may include a multiplying accumulator and supporting circuitry. The processing element 106 may additionally or alternatively include an arithmetic logic unit (ALU) or similar processing or logic circuity to perform desired operations.

Each processing element 106 includes or is connected to working memory 112 (e.g., random-access memory or RAM) dedicated to that processing element 106.

A processing element 106 may be connected with one or more neighboring processing elements 106 to share data and/or instructions. Processing element interconnections may be provided in the row direction, the column direction, or both.

The SIMD computing device 102 further includes a controller 114 connected to the processing elements 106 of each bank 108. A controller 114 is a processor (e.g., microcontroller, etc.) that may be configured with instructions to control the connected processing elements 106. The controller 114 is dedicated to the processing elements 106 of the bank 108 it serves. The controller 114 may be considered part of the bank 108 or may be considered external to the bank 108.

The controller 114 controls the connected processing elements 106 to perform the same operation on different data contained in each processing element 106. The controller 114 may further control the loading/retrieving of data to/from the processing elements 106, control the communication among processing elements 106, and/or control other functions for the processing elements 106. Any suitable number of controllers 114 may be provided to control the processing elements 106. Controllers 114 may be connected to each other for mutual communications. Controllers 114 may be arranged in a hierarchy, in which, for example, a main controller controls sub-controllers, which in turn control subsets of processing elements 106.

The SIMD computing device 102 further includes a bus 116 to which the controllers 114 connect. The bus 116 allows the sharing of information among the controllers 114 and banks 108 and the sharing of programs and data with the configuring computing device 104, via an external interface 118 of the SIMD computing device 102. The external interface 118 may include a Peripheral Component Interconnect Express (PCI-e) interface, Universal Serial Bus (USB) interface, or similar.

The SIMD computing device 102 is capable of performing operations using the processing elements 106 and specifically the operational circuitry 110 and working memory 112. Each operation may have a cost, which may be expressed in the number of clock cycles required by a processing element 106 or group of cooperating processing element 106 to perform the operation. Various numbers of cycles may be required to apply operands to the operational circuitry 110 to obtain a result. The particular operations performed, such as adding, multiplying, shifting, etc., may have different costs. Cost may depend on datatype or operand size. In addition, various numbers of cycles may be required to obtain or share data (e.g., an operand or component thereof) required to perform an operation, such as obtaining data from working memory 112, storing data in working memory 112, obtaining data from a connected neighboring processing element 106, providing data to a connected neighboring processing element 106, and so on.

The configuring computing device 104 includes a processor 120, memory 122, a non-transitory machine-readable medium 124, and an external interface 126 that may be the same as or similar to the external interface 118.

The processor 120 may include a central processing unit (CPU), a field-programmable gate array (FPGA), an application-specific integrated circuit (ASIC), or similar processor. The processor 120 may be one processor or more than one processor configured for collective operation. The processor 120 cooperates with the memory 122 and the medium 124 to execute instructions 128.

The memory 122 includes volatile working memory, such as a random-access memory (RAM).

The non-transitory machine-readable medium 124 may include an electronic, magnetic, optical, or other type of non-volatile physical storage device that encodes the instructions 128 that implement the functionality discussed herein. Examples of such storage devices include a non-transitory computer-readable medium such as a hard drive (HD), solid-state drive (SSD), read-only memory (ROM), electrically-erasable programmable read-only memory (EEPROM), or flash memory.

The instructions 128 may be directly executed, such as binary or machine code, and/or may include interpretable code, bytecode, source code, or similar instructions that may undergo additional processing to be executed. All of such examples may be considered executable instructions.

The instructions 128 generate sets of operational functions 130, which may be termed a composite function, that may be evaluated by the SIMD computing device 102. Example operational functions implement a target mapping of a target function. Operational functions 130 may be determined by breaking a target mapping into constituent functions that are referenced over different non-overlapping ranges of values.

The instructions 128 may further implement an IDE, compiler, and/or other tools to generate programs that are loadable onto the SIMD computing device 102 via a connection provided by the external interfaces 118, 126. Such programs may include or reference one or more operational functions 130.

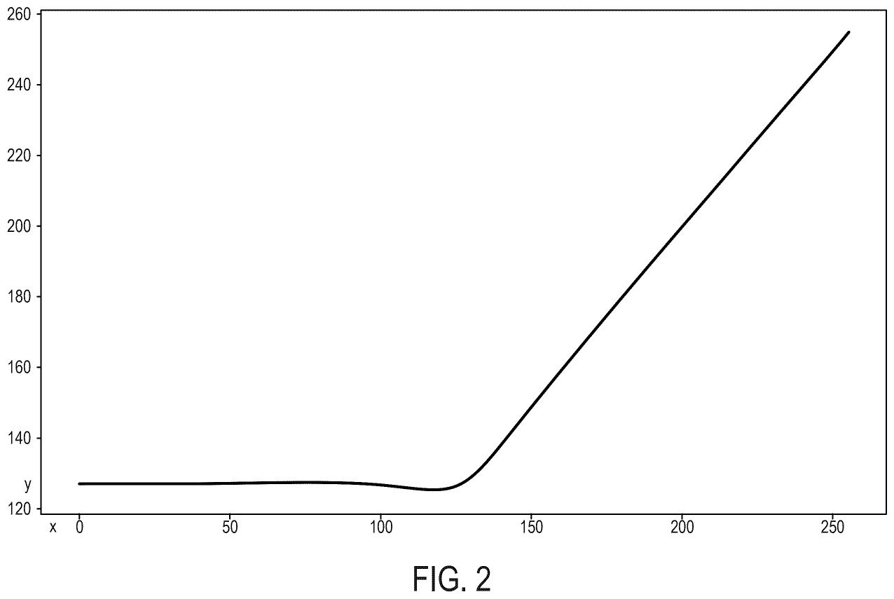

FIG. 2 shows an example target function, which in this case is a GELU function. The GELU function may be used as activation function in neural networks, for example. The general GELU function has the following formula:

$$g = 0.5 x ( 1 + \frac{2}{\sqrt{π}} ) {\int }_{0}^{\frac{x}{\sqrt{2}}} {e}^{- {t}^{2}} dt$$

The example GELU function shown in FIG. 2 is an integer version of the function.

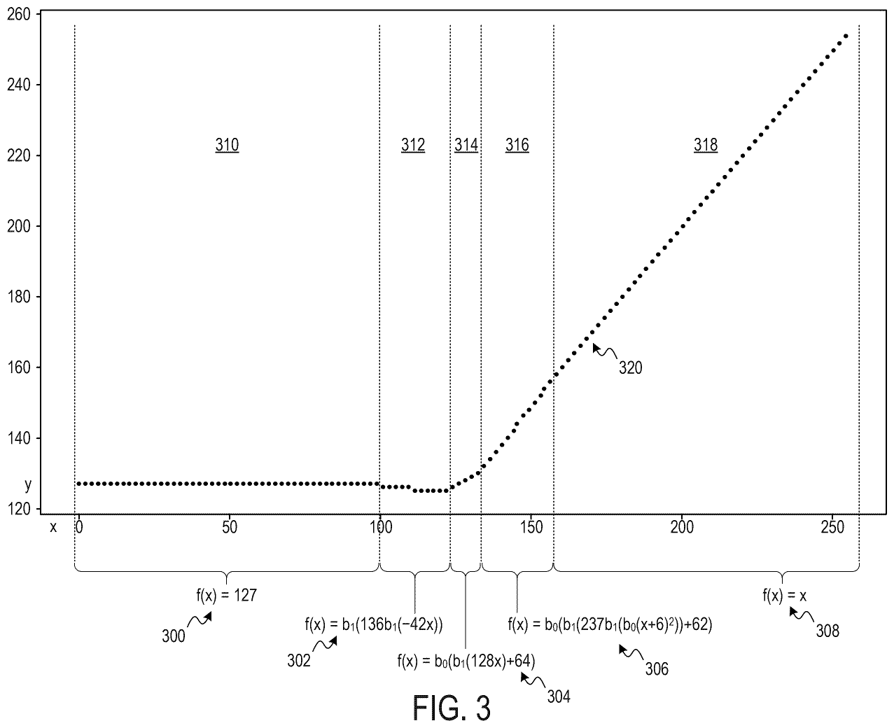

FIG. 3 shows example operational functions 300-308 that implement a target mapping 320 of the target function of FIG. 2. A target mapping 320 is a discrete, integer version of the target function and may be referred to as a lookup table (LUT). Each operational function 300-308 is confined to an operational range 310-318. In this example, five operational functions are provided, each function effective over one of five ranges. A given input value, x, will land in one of the ranges 310-318. The corresponding operational function may then be used to compute the value of the target function 300-308.

Operational functions 300-308 may contain various primitive functions, such as constants, linear functions, quadratic functions, and binary indexing functions. The set of operational functions 300-308, each function with a respective non-overlapping range, forms a composite function.

Example binary indexing functions b₀ and b₁ to take either the first byte or second byte of a multibyte product.

Indexing function b₀ is defined as:

$${b}_{0} ( x ) = x \& 255$$

As can be seen, indexing function b₀ returns the lowest eight bits of a binary integer. For example, if x=1101 1111 0011 1011, then b₀(x)=0011 1011.

Indexing function b₁ is defined as:

$${b}_{1} ( x ) = x ≫ 8$$

As can be seen, indexing function b₁ returns the bits in places nine through sixteen of a binary integer. Given the above example value of x, then b₁(x)=1101 1111.

In this example, the operational function 300 for the first operational range 310 is a constant, the operational function 302 for the second operational range 312 includes a linear function and a binary indexing function, the operational function 304 for the third operational range 314 includes a linear function and binary indexing functions, the operational function 306 for the fourth operational range 316 includes a quadratic function and binary indexing functions, and the operational function 308 for the fifth operational range 318 is a linear function. This serves to illustrate that a set of operational functions may include individual operational functions formed of various primitive functions.

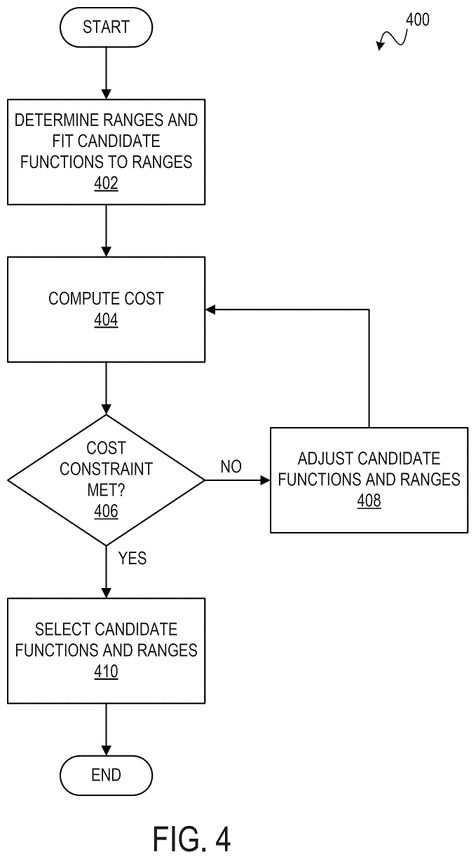

FIG. 4 shows an example method 400 for determining operational functions to model a target function. The method 400 may be implemented as processor-executable instructions, such as instructions 128 discussed above.

A block 402, with a target mapping of a target function, the target mapping is partitioned into non-overlapping ranges and candidate functions are fit to the target mapping within the ranges. A candidate function is fit to each range. This may include determining ranges of the target mapping or target function based on curvature of the target function and assigning a candidate function to each range. Further, this may include selecting candidate functions from a predefined set of primitive functions including a constant, a linear function, a quadratic function, and a binary indexing function, and then adjusting a coefficient of a candidate function.

At block 404 a cost function is evaluated for the candidate functions selected at block 402. The cost function computes an error and a processing load to execute the candidate functions within the respective ranges using a SIMD computing device or array of processing elements thereof, such as those shown in FIG. 1. A cost for the set of candidate functions selected at block 402 is thus computed.

At block 406, the cost determined at block 404 is compared to a cost constraint to determine whether the cost constraint is met. Example cost constraints include a minimization of the cost function. That is, the cost constraint may select the set of candidate functions and respective ranges that minimize an error of the candidate functions compared to the target mapping and minimize a processing load for a SIMD computing device to compute the candidate functions.

If the cost constraint is not met, then at block 408, the candidate functions and/or the ranges are adjusted. This may include redefining ranges, redefining one or more candidate functions, setting a coefficient or other value of a candidate function, and similar. The cost is then recomputed at block 404 and reevaluated at block 406.

If the cost constraint is met, then at block 410, the candidate functions and the ranges are selected to be operational functions and operational ranges that implement the target mapping of the target function.

The method 400 thus iterates over various candidate functions and ranges until a sufficiently optimum set is determined based on computational cost for a SIMD computing device.

The operations of the method 400 may be performed in an order other than that depicted and/or in parallel, informing one another, and hence are described above as blocks rather than steps. For example, given a target 8-bit LUT defined by: LUT: uint8_t[256] representing an optimal quantized function. The method 400 determines the piecewise operational functions which allow computation of LUT, where each operational function (i.e., each piece) has an associated cycle count. The method 400 aims to cover LUT exactly with the determined operational functions while minimizing the total cycle count of the operational functions.

In particular, the method 400 may proceed via dynamic programming, defining solve(i) to be the minimum cycle count to cover the prefix LUT[0 . . . i). Thus, solve(256) will correspond to the minimized total cycle count for LUT across the determined operational functions.

In the base case, solve(0)=0.

For solve(i), where i>0, consider the function f used at position i−1. By definition, f(i−1)==LUT[i−1]. Further, the function f may also cover more points, such as f(i−2)==LUT[i−2]. Thus, suppose the function f covers each position between a position j, where j<i. In particular, f(j)==LUT[j], and hence the minimum number of cycles to cover LUT to the position i can be determined using solve(j) for the LUT[0 . . . j) prefix and the number of cycles for f for LUT[j . . . i).

The method 400 may therefore be a recurrence according to solve(i)=min(solve(j)+cycles(f)) over all valid operational functions f.

For example, example pseudocode iterating through this recurrence may be given as:

```
def solve (i) :
  # minimum number of cycles required to cover the prefix
  ‘LUT [0..i)’
  # loop over all functions ‘f’ such that ‘f (i − 1) == LUT [i
  − 1]’
  cost = float (“inf”)
  for f in enumerate_fs (i − 1, LUT [i − 1]) :
    # compute minimum ‘j’ such that ‘f (k) == LUT [k]’ for
    all ‘j <= k < i’
    j = i − 1
    while j − 1 >= 0 and f (j − 1) == LUT [j − 1]:
      j −= 1
    cost = min (cost, solve (j) + cycles (f) )
  return cost
```

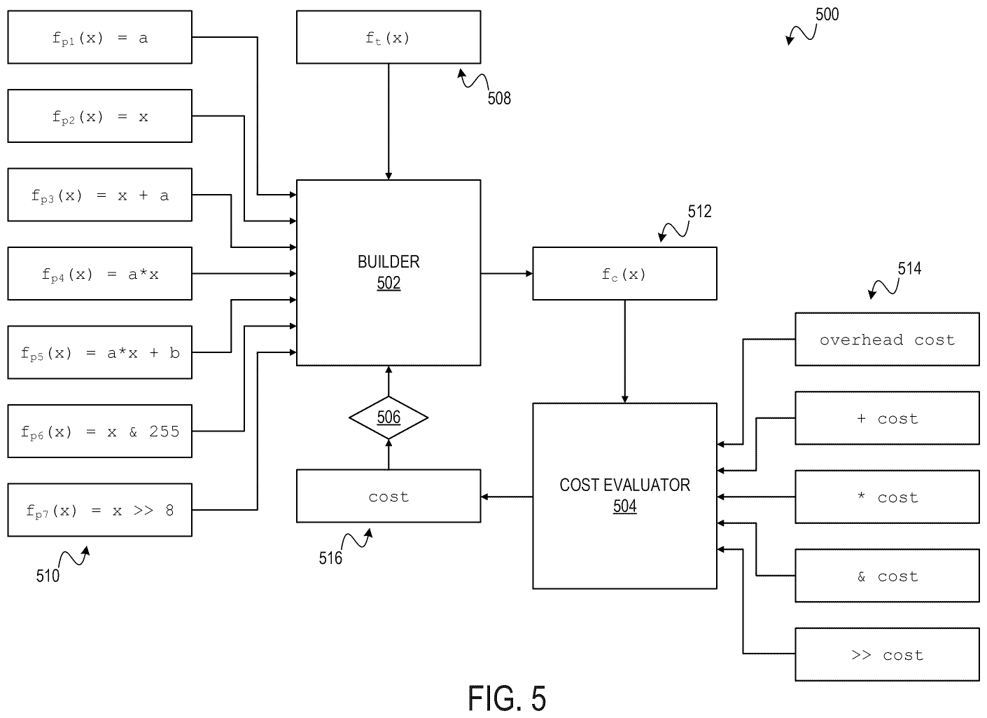

FIG. 5 shows an example system 500 to determine operational functions for a target function. The system 500 may be implemented as processor-executable instructions, such as instructions 128 discussed above.

The system 500 includes a builder 502, a cost evaluator 504, and acceptance logic 506, each of which may be implemented as a process, subroutine, function, class, or other programmatic entity.

The builder 502 references a target function 508 and a library of primitive functions 510, such as those discussed above. The builder 502 generates a composite function 512, as discussed above, that is to implement the target function 508 as a set of operational functions over respective operational ranges.

The cost evaluator 504 references various predetermined costs 514 associated with operations used in the primitive functions 510 that form the composite function 512, as well as an overhead cost, to compute a total cost 516 for the composite function 512.

The acceptance logic 506 compares the total cost 516 to a constraint (examples discussed above) and either accepts or rejects the composite function 512. If the total cost 516 meets the constraint, then the composite function 512 is accepted as the implementation of the target function 508. If the total cost 516 does not meet the constraint, then the acceptance logic 506 triggers the builder 502 to generate a new composite function 512 for evaluation.

In view of the above, it should be apparent that various functions may be implemented as operational functions and respective operational ranges that implement a target mapping. A cost constraint may be used to reduce or minimize error and clock cycles or other processing resource to execute the operational functions. As such, greater accuracy and performance characteristics may be obtained.

It should be recognized that features and aspects of the various examples provided above can be combined into further examples that also fall within the scope of the present disclosure. In addition, the figures are not to scale and may have size and shape exaggerated for illustrative purposes.

1. A non-transitory machine-readable medium comprising instructions that, when executed by a processor, cause the processor to:
partition a target mapping of a target function into ranges;
fit candidate functions to the ranges, wherein a candidate function is fit to each range;
adjust the candidate functions and the ranges based on a cost function, wherein the cost function computes a processing load to execute the candidate functions with the ranges using an array of single instruction, multiple data (SIMD) processing elements; and
select the candidate functions and the ranges that minimize the cost function as operational functions and operational ranges that implement the target mapping.

2. The non-transitory machine-readable medium of claim 1, wherein the instructions are to adjust the candidate functions and the ranges to minimize the cost function.

3. The non-transitory machine-readable medium of claim 1, wherein the instructions are to adjust a coefficient of a candidate function.

4. The non-transitory machine-readable medium of claim 1, wherein the instructions are to select the candidate functions from a predefined set of primitive functions including:
a constant;
a linear function;
a quadratic function; and
a binary indexing function.

5. The non-transitory machine-readable medium of claim 1, wherein the cost function computes a number of cycles to execute the candidate functions with the ranges.

6. The non-transitory machine-readable medium of claim 1, wherein the ranges are non-overlapping.

7. A computing device comprising:
memory; and
a processor connected to the memory, the processor configured to:
partition a target mapping of a target function into ranges;
fit candidate functions to the ranges, wherein a candidate function is fit to each range;
adjust the candidate functions and the ranges based on a cost function, wherein the cost function computes a processing load to execute the candidate functions with the ranges using an array of single instruction, multiple data (SIMD) processing elements; and
select the candidate functions and the ranges that minimize the cost function as operational functions and operational ranges that implement the target mapping.

8. The device of claim 7, wherein the processor is configured to adjust the candidate functions and the ranges to minimize the cost function.

9. The device of claim 7, wherein the processor is configured to adjust a coefficient of a candidate function.

10. The device of claim 7, wherein the processor is configured to select the candidate functions from a predefined set of primitive functions including:
a constant;
a linear function;
a quadratic function; and
a binary indexing function.

11. The device of claim 7, wherein the cost function computes a number of cycles to execute the candidate functions with the ranges.

12. The device of claim 7, wherein the ranges are non-overlapping.

13. The device of claim 7, further comprising an external interface configured to load a representation of the operational functions and operational ranges onto a SIMD computing device.
